(19) United States
(12) Patent Application Publication
(10) Pub. No.: US 2014/0282025 A1
(43) Pub. Date: Sep. 18, 2014

(54) MATCHING WEBSITE VISITS WITH CONTENT SELECTION PARAMETERS

(71) Applicants: Jieyan Fan, Fremont, CA (US); Sagik Nandy, Los Gatos, CA (US); Yuan Zhuge, Mountain View, CA (US); Jesse Savage, Redwood City, CA (US); George Su, Mountain View, CA (US)

(72) Inventors: Jieyan Fan, Fremont, CA (US); Sagik Nandy, Los Gatos, CA (US); Yuan Zhuge, Mountain View, CA (US); Jesse Savage, Redwood City, CA (US); George Su, Mountain View, CA (US)

(21) Appl. No.: 13/830,468

(22) Filed: Mar. 14, 2013

(51) Int. Cl. G06F 3/0481

(52) U.S. Cl. CPC G06F 3/0481
USPC 715/736

(57) ABSTRACT

Methods and systems for matching a plurality of visits to a website with a plurality of content selection parameters including aggregating a number of visits to the website, determining whether the website includes an identifier, based on the determination, retrieving information associated with the identifier, wherein the information comprises the plurality of content selection parameters, and matching the plurality of content selection parameters with the plurality of visits to the website to create a report.

### BACKGROUND

The present disclosure relates generally to systems and methods for matching a plurality of visits to a website with a plurality of content selection parameters.

### SUMMARY

In one implementation, in general, a computer-implemented method for matching a plurality of visits to a website with a plurality of content selection parameters is disclosed. The method includes aggregating a number of visits to the website. The method further includes determining whether the website includes an identifier. The method yet further includes, based on the determination, retrieving information associated with the identifier, wherein the information comprises the plurality of content selection parameters. The method also includes matching the plurality of content selection parameters with the plurality of visits to the website to create a report.

In another implementation, in general, a system for matching a plurality of visits to a website with a plurality of content selection parameters is disclosed. The system includes a processing circuit. The processing circuit is operable to aggregate a number of visits to the website. The processing circuit is further operable to determine whether the website includes an identifier. The processing circuit is also operable to, based on the determination, retrieving information associated with the identifier, wherein the information comprises the plurality of content selection parameters. The processing circuit is operable to match the plurality of content selection parameters with the plurality of visits to the website to create a report.

In yet another implementation, in general, a computer-readable storage medium having instructions therein, the instructions being executable by a processor to cause the processor to perform operations is disclosed. The operations include aggregating a number of visits to the website. The operations further include determining whether the website includes an identifier. The operations yet further include, based on the determination, retrieving information associated with the identifier, wherein the information comprises the plurality of content selection parameters. The operations also include matching the plurality of content selection parameters with the plurality of visits to the website to create a report.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is an example of a block diagram of an embodiment of an environment for matching website visits with content selection parameters;

FIG. 2A is an illustration of an example system for providing information to a user in accordance with a described implementation;

FIG. 2B is a detailed illustration of the processing component of the system described in FIG. 2A, in accordance with a described implementation;

FIG. 3 is a flow diagram of a method of matching a plurality of visits to a website with a plurality of content selection parameters, in accordance with a described implementation.

FIG. 4 is an example of a display provided to a website owner, in accordance with a described implementation; and

FIG. 5 is a detailed illustration of a display of a specific content selection parameter broken down into further sub-content selection parameters, in accordance with a described implementation.

Like reference numbers and designations in the various drawings indicate like elements.

### DETAILED DESCRIPTION

To measure the effectiveness of a campaign that presents content to a user, monitoring the number of visits and/or conversions from traffic to the website may be monitored. For example, the owner of a campaign may want to monitor the number of visitors to their website via a content item, such as an advertisement.

One way to monitor the number of visits is to determine whether the number of visits to a website increases due to the content item. For example, an automobile manufacturer may want to implement an advertisement campaign for its latest model of automobile. The automobile manufacturer wants to know whether website traffic from a specific age group of people is increased. A content selection parameter related to the specific age group of people may give the automobile manufacturer the ability to determine whether that specific age group of people is visiting their website. In another example, a fashion shoe website may want to know the percentage of website traffic from a specific gender.

One implementation is to identify the content selection parameters related to the website visitor by creating a registration for website visitors, where the website visitors can disclose content selection parameters that may include age, gender, personal preferences, etc. In another implementation, the content selection parameter may be inferred based on the user history data.

Content selection parameters may be stored in a unique identifier. In some implementations, the unique identifier is a cookie and the content selection parameter can be derived from the cookie. For example, the cookie may include a key that represents previous user events associated with the user, the order in which these events occurred, etc or the cookie may include user history data.

The identifier may be associated with a third party website or third party owner, which may store the content selection parameter. It is difficult to connect the website traffic/visits with the identifier containing the content selection parameter, while protecting the privacy of the users.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, Zip code, or state level), so that a particular location of a user cannot be determined. Thus, the user may have control over how information is collected about the user and used by a server.

The systems and methods described herein implement a way to connect the contact selection parameter stored by the identifier with the website visits. For example, the identifier may be a cookie stored by a website separate from the visited website. In the implementations described herein, the identifier may be associated with the website visits, which allows the website owner to obtain the content selection parameters of the website visits.

For each visit to a website, a determination is made as to whether the website includes the unique identifier. If a unique identifier is present, then the content selection parameters associated with the unique identifier are retrieved. The retrieved identifier is attached to the visit. The visits and the content selection parameters are matched to generate a report showing the types of visitors to the website.

The techniques described herein can afford users fine-grained privacy protection by associating unique users of every segmentation and only reporting the content selection parameters if the number of unique visitors is above a defined threshold. For example, the report provided to the website owner does not include any personally identifiable information of a single user. Personally identifiable information is not disclosed by the user or to the website owner.

The performance of content items, such as advertisements, may be more effectively determined using the implementations described herein. The website owner may understand the performance metrics of the content items for specific segments of website traffic, without having to explicitly provide confidential user registration data.

FIG. 1 is a block diagram of a computer system 100 in accordance with a described implementation. System 100 includes client device 102, which may communicate with other computing devices via a network 106. For example, client device 102 may communicate with one or more content sources 108(a) to 108(n) (generally referred to as content sources 108). Content sources 108 may provide webpages and/or media content (e.g., audio, video, and other forms of digital content) to client device 102. System 100 may include server 104, which provides advertisement data to other computing devices over network 106.

Network 106 may be any form of computer network that relays information between client device 102, server 104, and content sources 108. For example, network 106 may include the Internet and/or other types of data networks, such as a local area network (LAN), a wide area network (WAN), a cellular network, satellite network, or other types of data networks. Network 106 may include any number of computing devices (e.g., computer, servers, routers, network switches, etc.) that are configured to receive and/or transmit data within network 106. Network 106 may include any number of hardwired and/or wireless connections. For example, client device 102 may communicate wirelessly (e.g., via WiFi, cellular, radio, etc.) with a transceiver that is hardwired (e.g., via a fiber optic cable, a CAT5 cable, etc.) to other computing devices in network 106. Although FIG. 2 shows a network 106 between client device 102 and server 104, client device 102 and server 104 may be on the same network 106. In some implementations, there are multiple networks 106 between client device 102 and server 104. Network 106 may be a private network or a public network.

Network 106 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some implementations, different types of data may be transmitted via different links and standards. In other implementations, the same types of data may be transmitted via different links and standards.

Network 106 may be any type and/or form of network. The geographical scope of the network 106 may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 106 may be an overlay network which is virtual and sits on top of one or more layers of other networks. The network 106 may be of any such network topology as known to those ordinarily skilled in the art capable of supporting the operations described herein. The network 106 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 106 may be a type of a broadcast network, a telecommunications network, a data communication network, or a computer network.

Client device 102 may be any number of different user electronic devices configured to communicate via network 106 (e.g., a laptop computer, a desktop computer, a tablet computer, a smartphone, a digital video recorder, a set-top box for a television, a video game console, etc.). Client device 102 is shown to include a processor 112 and a memory 114, i.e., a processing circuit. Memory 114 stores machine instructions that, when executed by processor 112, cause processor 112 to perform one or more of the operations described herein. Processor 112 may include a microprocessor, application-specific integrated circuit (ASIC), field-programmable gate array (FPGA), etc., or combinations thereof. Memory 114 may include, but is not limited to, electronic, optical, magnetic, or any other storage or transmission device capable of providing processor 112 with program instructions. Memory 114 may include a floppy disk, CD-ROM, DVD, magnetic disk, memory chip, ASIC, FPGA, read-only memory (ROM), random-access memory (RAM), electrically-erasable ROM (EEPROM), erasable-programmable ROM (EPROM), flash memory, optical media, or any other suitable memory from which processor 112 can read instructions. The instructions may include code from any suitable computer-programming language such as, but not limited to, C, C++, C#, Java, JavaScript, Perl, Python and Visual Basic.

Client device 102 may include one or more user interface devices. In general, a user interface device refers to any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, etc.). A wide variety of I/O devices may be present in the client device 102. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. The one or more user interface devices may be internal to a housing of client device 102 (e.g., a built-in display, microphone, etc.) or external to the housing of client device 102 (e.g., a monitor connected to client device 102, a speaker connected to client device 102, etc.), according to various implementations. For example, client device 102 may include an electronic display 116, which visually displays webpages using webpage data received from content sources 108 and/or from server 104.

Client device 102 may include a combination of multiple input or output devices. Client device 102 may allow gesture recognition inputs through combining some of the inputs and outputs. Client device 102 may provide for facial recognition which may be utilized as an input for different purposes including authentication and other commands. Client device 102 may provide for voice recognition and inputs.

Client device 102 may have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, may have larger surfaces, such as on a table-top or on a wall, and may also interact with other electronic devices. Some I/O devices, display devices or group of devices may be augment reality devices. The I/O devices may be controlled by an I/O controller. The I/O controller may control one or more I/O devices, such as, e.g., a keyboard and a pointing device, e.g., a mouse or optical pen. Furthermore, an I/O device may also provide storage and/or an installation medium for the client device 102. In still other implementations, the client device 102 may provide USB connections (not shown) to receive handheld USB storage devices. In further implementations, an I/O device may be a bridge between the system bus and an external communication bus, e.g. a USB bus, a SCSI bus, a FireWire bus, an Ethernet bus, a Gigabit Ethernet bus, a Fibre Channel bus, or a Thunderbolt bus.

In some implementations, display devices may be connected to I/O controller. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopy. Display devices may also be a head-mounted display (HMD). In some implementations, display devices or the corresponding I/O controllers may be controlled through or have hardware support for OPENGL or DIRECTX API or other graphics libraries.

In some implementations, the client device 102 may include or connect to multiple display devices, which each may be of the same or different type and/or form. As such, any of the I/O devices and/or the I/O controller may include any type and/or form of suitable hardware, software, or combination of hardware and software to support, enable or provide for the connection and use of multiple display devices by the client device 102. For example, client device 102 may include any type and/or form of video adapter, video card, driver, and/or library to interface, communicate, connect or otherwise use the display devices. In one implementation, a video adapter may include multiple connectors to interface to multiple display devices. bIn other implementations, the client device 102 may include multiple video adapters, with each video adapter connected to one or more of the display devices. In some implementations, any portion of the operating system of the client device 102 may be configured for using multiple displays. In other implementations, one or more of the display devices may be provided by one or more other client devices connected to the client device 102, via the network 106. In some implementations software may be designed and constructed to use another computer's display device as a second display device for the client device 102.

Client device 102 may comprise a storage device (e.g. one or more hard disk drives or redundant arrays of independent disks) for storing an operating system or other related software, and for storing application software programs. Examples of storage device include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device may be non-volatile, mutable, or read-only. Some storage device may be internal and connect to the client device 102 via a bus. Some storage device may be external and connect to the client device 102 via a I/O device that provides an external bus. Some storage device may connect to the client device 102 via the network interface over a network 106. Some client devices 102 may not require a non-volatile storage device and may be thin clients or zero clients 102. Some storage device may also be used as a installation device, and may be suitable for installing software and programs. Additionally, the operating system and the software can be run from a bootable medium, for example, on a bootable CD.

Client device 102 may also install software or application from an application distribution platform. An application distribution platform may facilitate installation of software on a client device 102. An application distribution platform may include a repository of applications on a server 104 or a cloud, which the client device 102 may access over a network 106. An application distribution platform may include application developed and provided by various developers. A user of a client device 102 may select, purchase and/or download an application via the application distribution platform.

Furthermore, the client device 102 may include a network interface to interface to the network 106 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one implementation, the computing device 100 communicates with other computing devices 100′ via any type and/or form of gateway or tunneling protocol e.g. Secure Socket Layer (SSL) or Transport Layer Security (TLS), etc. The network interface may comprise a built-in network adapter, network interface card, PCMCIA network card, EXPRESSCARD network card, card bus network adapter, wireless network adapter, USB network adapter, modem or any other device suitable for interfacing the client device 102 to any type of network capable of communication and performing the operations described herein.

Client device 102 may operate under the control of an operating system, which controls scheduling of tasks and access to system resources. Device 102 can be running any operating system such as any embedded operating system, any real-time operating system, any open source operating system, any proprietary operating system, any operating systems for mobile computing devices, or any other operating system capable of running on the computing device and performing the operations described herein.

Client device 102 may be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some implementations, client device 102 may have different processors, operating systems, and input devices consistent with the device.

Client device 102 may include a gaming system. In some implementations, client device 102 is a digital audio player. Some digital audio players may have other functionality, including, e.g., a gaming system or any functionality made available by an application from a digital application distribution platform. In some implementations, client device 102 is a portable media player or digital audio player supporting file formats including, but not limited to, MP3, WAV, M4A/AAC, WMA Protected AAC, RIFF, Audible audiobook, Apple Lossless audio file formats and .mov, .m4v, and .mp4MPEG-4 (H.264/MPEG-4 AVC) video file formats. In some implementations, client device 102 is a tablet. In some implementations, client device 102 includes a combination of devices, e.g. a smartphone combined with a digital audio player or portable media player. In yet another implementation, client device 102 is a laptop or desktop computer equipped with a web browser and a microphone and speaker system, e.g. a telephony headset. In these implementations, the client device 102 is web-enabled and can receive and initiate phone calls. In some implementations, a laptop or desktop computer is also equipped with a webcam or other video capture device that enables video chat and video call.

Content sources 108 are electronic devices connected to network 106 and provide media content to client device 102. For example, content sources 108 may be computer servers (e.g., FTP servers, file sharing servers, web servers, etc.) or other devices that provide media content to client device 102 via network 106. Media content may include, but is not limited to, webpage data, a movie, a sound file, pictures, advertisements, and other forms of data. For example, in order to obtain webpage data to render a webpage, communication by client device 102 across network 106 involves requesting the webpage data from content sources 108.

Server 104 may aggregate a number of visits to a website from content sources 108, in response to receiving a selection of media content from client device 102. The website may include a collection of web pages formatted in hypertext markup language (HTML), which may include graphics, text, multimedia content, programming elements, such as scripts, etc. For example, client device 102 may receive webpage data associated to an advertisement having impression data, e.g., the user clicked on. In response to providing webpage data, server 104 may determine whether the website associated with the webpage data has an identifier, such as a cookie, from reviewing content sources 108. Server 104 may retrieve information associated with the identifier, which may include content selection parameters. The content selection parameters may be matched to the visits to the website. Server 104 may then provide a report to a publisher of the website with the results of the content selection parameters matched with the visits to the website. The report may include interests, keywords, hobbies, gender, income, race, household size, education, location, etc. of an aggregation of client devices that requested the web page.

The privacy of the users of the client devices may be protected by anonymizing the impression data for the user so that the webpage data stored cannot be associated with an individual user. In an example, the identity of a user may be obscured, set to a unique number not associated with the user, etc. The location of the user may be a generic location, such as a zip code.

Referring now to FIG. 2A, a system 200 for providing a report to a publisher of a website is shown, according to one example.

In a brief overview, system 200 includes storage module 202, importer 204, database 206, pipeline processing unit 207 website visits database 208, extractor 209, and interface 210. In some implementations, system 200 may include more or less components. System 200 may import and report webpage data related to content selection parameters by recording website visits and retrieving identifiers from webpage data. System 200 may be implemented by a server computer, such as server 104.

Storage module 202 may comprise any of the non-volatile memory elements described above in FIG. 1. In other implementations, the storage module includes a database, such as MySQL, etc. In still other implementations, storage module 202 may store a variety of data on a cloud-based storage system. The data stored in storage module 202 may be indexed by a cookie.

Storage module 202 may be accessed by importer 204 in a number of ways. For example, storage module 202 may be queried based on the cookie. In another example, a direct read of the storage module 202 may be implemented. In yet another example, storage module 202 may include a job that provides data as files, which can then be read.

Importer 204 imports, i.e., processes, a set of data that is related to the cookie. Importer 204 may include a server that processes data stored either in storage module 202 or a filesystem. Importer 204 receives input, such as the large set of data related to the cookie, and distributes the input to the server. For example, the input may be sub-divided into smaller problems and then passed back to the server. The server may collect the answers to all of the smaller programs and combine them to form an answer, i.e., reading the webpage data of the user (visits and content selection parameters related to the visit) to populate database 206.

Importer 204 provides the set of data from storage module 202 to database 206. For example, importer 204 reads audience data from storage module 202 and populates database 206. Database 206 may then store the content selection parameter in an indexed manner based on the cookie, in order for the data stored in database 206 to be accessed, manipulated, modified, etc.

Database 206 may be a standalone database or a component of a general purpose database management system (DBMS). The DBMS may be, for example, a server providing multi-user access to a number of databases. Database 206 may provide data to pipeline processing unit 207 for further processing, which is illustrated in more detail in FIG. 2B.

The data from database 206 may be further processed, using a processing pipeline 207, which is illustrated with more detail in FIG. 2B. Referring briefly to FIG. 2B, processing pipeline 207 includes a task injector 207a, database 207b, task worker 207c, and task manager 207d.

In a brief overview, processing pipeline 207 may receive input, such as website data, from website visits database 208, which may include all website traffic from users. Website visits database 208 may be a standalone database or a component of a general purpose database management system (DBMS). The DBMS may be, for example, a server providing multi-user access to a number of databases.

Processing pipeline 207 begins the process to merge the website hits from database 208 with user data from database 206.

Task injector 207a performs the scan of database 207b for web properties that have the content selection parameter feature turned on. For example, web properties may allow demographic and/or audience reporting of the visitors to a website. In some examples, the determination of whether the feature is turned on is performed using a Boolean flag. Task injector 207a may organize database 207b by each content selection parameter-enabled web property.

Task worker 207c reads n visits and looks up the cookie from database 206. If a cookie is found for the website visit, then the website visit is merged with the cookie.

Processing pipeline 207 is implemented based on task manager 207d. Task manager 207d includes task protocol that governs tasks. A task may include a number of web properties. A subtask may map to one web property.

Once the data is processed by processing pipeline 207, then task worker 207c performs matching, as shown in FIG. 2A.

Extractor 209 reads the result from task worker 207c to generate a report. Extractor 209 may provide the report for display to a client device 102 via interface 210. Extractor 209 may include Interface 210 may communicate between extractor 209 and a client device via a network, such as network interface.

Client device 102 may display the matching of the cookie along with the website visit in the form of a report. For example, FIGS. 5 and 6 are each an example of the display provided to a client device 102. The content owner may determine which content selection parameters and associated performance metrics to display.

FIG. 3 is an example of a flow diagram of a method 300 of matching a plurality of visits to a website with a plurality of estimated content selection parameters. Example method 300 may be implemented by various combinations of systems, such as system 300. Example 300 may be performed online or offline.

Example method 300 may begin at block 302, where a number of visits to the website are aggregated. The aggregation of the visits to the website may take place over a period of time. The period of time may be defined by the content owner or the system itself. The aggregation of visits may include counting the number of pageviews, where a pageview represents a request to load a single page of a website. Website visits database 208 may index and store the visits to the website.

In some implementations, other metrics may be aggregated, such as the number of online transactions, the sum of transaction revenues, the number of click thoughts, the sum of costs, etc.

At block 304, a determination is made whether the website includes an identifier. The identifier that the system is looking for is an identifier that includes information related to content selection parameters. In some implementations, the identifier is associated with a domain that is separate from the website that is visited.

At block 306, based on the determination, the information associated with the identifier is retrieved. For example, storage module 202 may include data indexed by the identifier. For example, when a user accesses the website, the website provides the identifier, such as a cookie, to the user's client device. The content of the cookie may be stored by the client and information associated with the identifier may be stored in storage module 202. The information associated with the identifier may include information related to the user, the user's client device, etc., such as user preference data for content, such as advertisements.

The retrieved information includes several estimated content selection parameters. Content selection parameters may include criteria such as demographic and selection criteria. Examples of this criteria may include contextual data such as interests, keywords, hobbies, etc., a visitor's age, gender, location, primary language, etc. of the visitor or the device that requests the website. The time and date of the visit may also be determined.

Extractor 209 may perform the conversion of the standalone website traffic data and the standalone content selection parameters into a merged set of data that can be used by a website publisher to determine the number of visits/hits and conversion rate for a specific segment, as defined by a content selection parameter such as gender, age, interest, and so forth.

Extractor 209 receives the merged cookie and the content selection parameter to expose new dimensions for content selection parameters, such as demographics, interest data, etc. Extractor 209 can support segmentation of any of the content selection parameters, which can be determined and/or modified by the content owner. For example, the content owner may define a segmentation of a specific content selection parameter such as an age group, an interest group, or a specific gender. The system may also modify extractor 209 to include additional content selection parameters.

If the content selection parameter is gender, then the gender may include “male”, “female”, “unknown.”

If the content selection parameter is age, then the age may include “0-17,” “18-24,” “25-34,” “35-44,” “45-54,” “55-64,” “65+,” or “unknown.” Extractor 209 may support any segmentation for age, which may be determined by the content owner.

If the content selection parameter is interest data, then there may be multiple brackets since the same visitor may have multiple interests.

At block 308, several estimated content selection parameters are matched with several visits to the website to create a report. The report provides the content owner with information about the visitors to the website. In some implementations, the report may be organized according to each estimated content parameter. To protect the privacy of users, the system may anonymize the information about the user so that the information stored is not associated with the user. In some implementations, the identity of the user may be obscured. Additional techniques may be used to protect the privacy of the user.

In some implementations, the report may be provided to the website owner. The website owner may be the content owner, i.e., advertiser. In other implementations, the report may not be provided. For example, a determination may be made as to whether the match of the estimated content selection parameters with the visits to the website meets a threshold. The threshold may be an amount of visitors greater than n unique visitors to the website, where n is a number set by the system to maintain anonymity of the users. If the match meets or exceeds the threshold (is greater than n number of unique visitors), then the report is displayed. In yet another implementation, the matches of the estimated content selection parameters with the visits to the website may be aggregated. It may be of interest to the system or the content owner, the number of matches that are made. Extractor 209 provides the matching of the cookie along with the website visit for display to a client device 102 via interface 210. Interface 210 may communicate between extractor 209 and a client device via a network, such as network interface. The content owner may determine which content selection parameters and associated performance metrics to display.

Based on the report, a content item may be selected to provide to the website. In some implementations, the content owner may select an advertisement that is relevant to the visitors of the website based on the knowledge gleaned from the report. For example, the content owner may provide an advertisement based on the age of the visitors to the website.

A performance characteristic of the content item may also be determined from the report. For example, the content owner may know the conversion rate for visitors having a certain content selection parameter based on the report. In another example, the report may provide the number of website visits, the number of transactions, and/or the sum of transaction revenues for females between 25-34 with interests, such as fashion and/or home décor.

FIG. 4 is an example of display 400 provided to a publisher of a website, such as website owner. Display 400 may be an overview of content selection parameters for a given time period 301. In FIG. 4, for example, content selection parameters 1-5 are shown as 403, 405, 407, 409 and 411, respectively.

Content selection parameter 1 (403) displays the percentage of visitors based on age. Content selection parameter 2 (405) displays the percentage of visitors based on gender. Content selection parameter 3 (407) displays the percentage of visitors based on interest data. Content selection parameter 4 (409) displays the percentage of visitors based on primary language of the visitor. Content selection parameter 5 (411) displays the percentage of visitors based on region.

Each content selection parameter may also display a variety of statistics. For example, each may include what percentage of total visitors had a specific interest, were a specific age, etc. In another example, each content selection parameter may show the total number of conversions based on age, gender, location, etc. Display 400 may include any variation of statistics of the content selection parameter matched with the visitor/visits.

FIG. 5 is a detailed illustration of a display of a specific content selection parameter broken down into further sub-content selection parameters. Display 500 selects age as the content selection parameter and the segmentation/bracket of “age 25-34.” Section 502 of display 500 may include a time period for displaying the age of the website traffic. Section 504 of display 500 may include the ability to compare segments/brackets. For example, it may be desirable to compare the website traffic of various age segments.

Section 506 of display 500 provides graphic 506, which outlines the number of visitors at certain times with the selected age segment. Graphic 506 may be shown as a line graph, bar graph, pie chart, or any other appropriate display. Graphic 506 may also include a counter for visits, unique visits, page views, etc. along with the website's averages for each of these figures, as shown in FIG. 5.

Sections 508, 510, 512, and 514 depict various figures as related to their respective content selection parameter. For example, section 508 shows the percentage of female and male visitors to the website, a graphical representation of the percentages, and the percentage of the total number of visitors having a gender, as identified by the cookie. Section 510 shows the percentage of website visitor based on interest data, a graphical representation of the percentages, and the percentage of the total number of website visitors having an interest, as identified by the cookie. Section 512 shows the percentage of website visitors based on primary language, a graphical representation of the percentages, and the percentage of the total number of website visitors having an identified primary language, as identified by the cookie. Section 514 shows the number of website visitors based on region, a graphical representation of the number of visitors, and the percentage of the total number of website visitors having an identified region, as identified by the cookie. The graphical representation for each content selection parameter may be a pie chart, line graph, bar graph, world map, Venn diagram or any other appropriate graphical representation.

Implementations of the subject matter and the functional operations described in this specification can be implemented in other types of digital electronic circuitry, or in computer software, firmware, or hardware, including the structures disclosed in this specification and their structural equivalents, or in combinations of one or more of them.

Implementations of the subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, i.e., one or more modules of computer program instructions, encoded on one or more computer storage media for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is tangible.

The operations described in this specification can be performed by a data processing apparatus on data stored on one or more computer-readable storage devices or received from other sources.

The term “data processing apparatus” or “computing device” encompasses all kinds of apparatus, devices, and machines for processing data, including by way of example a programmable processor, a computer, a system on a chip, or multiple ones, or combinations of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for matching a plurality of visits to a website with a plurality of content selection parameters comprising:
aggregating a number of visits to the website;
determining whether the website includes an identifier;
based on the determination, retrieving information associated with the identifier, wherein the information comprises the plurality of content selection parameters; and
matching the plurality of content selection parameters with the plurality of visits to the website to create a report.

2. The method of claim 1, further comprising:
based on the report, selecting a content item to provide to the website.

3. The method of claim 1, further comprising:
based on the report, determining a performance characteristic of the content item.

4. The method of claim 1, further comprising:
providing the report to a website owner.

5. The method of claim 4, wherein the website owner is an advertiser.

6. The method of claim 1, wherein the identifier is associated with a domain that is separate from the website that is visited.

7. The method of claim 1, wherein the report is organized according to each content selection parameter.

8. The method of claim 1, further comprising:
determining whether the match of the plurality of content selection parameters with the visits to the website meets a threshold.

9. The method of claim 8, wherein the match meets the threshold when the match includes greater than n unique visitors to the website.

10. The method of claim 9, if the match meets the threshold, then displaying the report.

11. The method of claim 1, further comprising:
aggregating the matches of the plurality of content selection parameters with the visits to the website.

12. A system for matching a plurality of visits to a website with a plurality of content selection parameters, the system comprising a processing circuit operable to:
aggregate a number of visits to the website;
determine whether the website includes an identifier;
based on the determination, retrieve information associated with the identifier, wherein the information comprises the plurality of estimated content selection parameters; and
match the plurality of estimated content selection parameters with the plurality of visits to the website to create a report.

13. The system of claim 12, the processing circuit further operable to:
based on the report, select a content item to provide to the website.

14. The system of claim 12, the processing circuit further operable to:
based on the report, determine a performance characteristic of the content item.

15. The system of claim 12, the processing circuit further operable to:
provide the report to a website owner.

16. The system of claim 12, wherein the identifier is associated with a domain that is separate from the website that is visited.

17. The system of claim 12, the processing circuit further operable to:
determine whether the match of the plurality of content selection parameters with the visits to the website meets a threshold.

18. The system of claim 12, the processing circuit further operable to, wherein the match meets the threshold when the match includes greater than n unique visitors to the website.

19. The system of claim 12, the processing circuit further operable to, if the match meets the threshold, then displaying the report.

20. A computer-readable storage medium having instructions therein, the instructions being executable by a processor to cause the processor to perform operations comprising:
aggregating a number of visits to the website;
determining whether the website includes an identifier;
based on the determination, retrieving information associated with the identifier, wherein the information comprises the plurality of content selection parameters; and
matching the plurality of content selection parameters with the plurality of visits to the website to create a report.
